(19) United States
(12) Patent Application Publication
(10) Pub. No.: US 2015/0183133 A1
(43) Pub. Date: Jul. 2, 2015

(54) GRIPPING MECHANISM, CUTTING DEVICE AND CUTTING METHOD FOR LIQUID CRYSTAL PANEL

(71) Applicant: Huping Jia, Shenzhen City (CN)

(72) Inventor: Huping Jia, Shenzhen City (CN)

(21) Appl. No.: 14/235,024

(22) PCT Filed: Dec. 30, 2013
(86) PCT No.: PCT/CN2013/090842

§ 371 Date: Jan. 24, 2014

(51) Int. Cl. B28D 7/04; B28D 1/22

(52) U.S. Cl. CPC B28D 7/046; B28D 1/22

(57) ABSTRACT

A gripping mechanism is disclosed. The gripping mechanism includes a first gripping arm and a second gripping arm movable with respect to each other. Each of the gripping arms includes a fixing arm and a clasping portion connecting to the fixing arm. The clasping portions of the two gripping arms are arranged opposite to each other to form a gripping space therebetween. The clasping portion includes a vacuum hole connecting to a vacuum controlling device, and the vacuum controlling device sucks a gripped target via performing a vacuum suction by the vacuum hole when the gripping mechanism performs a gripping process. In addition, a cutting device of liquid crystal panel including the above gripping mechanism and a cutting method adopting the cutting device are disclosed.

### BACKGROUND OF THE INVENTION

1. FIELD OF THE INVENTION

The present disclosure relates to liquid crystal display manufacturing technology, and more particularly to a gripping mechanism for liquid crystal devices, a cutting device including the gripping mechanism, and a cutting method adopting the cutting device for cutting the liquid crystal devices.

2. DISCUSSION OF THE RELATED ART

Liquid crystal displays (LCD) are thin and flat display devices including a certain amount of colorful or black/white pixels. The LCD is arranged in front of light sources or reflective surfaces. As the power consumption of LCDs is low, and the LCDs are characterized by advantages such as, high display quality, small dimension, and light weight, and thus have been greatly adopted.

Generally, LCDs include liquid crystal cells having two transparent substrates and liquid crystal enclosed between the two substrates. The main trend of LCDs is thin film transistor (TFT) LCD. The manufacturing process of the TFT LCD can be roughly divided into three parts including TFT arrays and color filtering substrates, LC cell assembly, and liquid crystal module (LCM).

In the LCD manufacturing process, usually a huge panel is processed and then the huge panel is cut into small-sized panel by the liquid crystal panel cutting device. The liquid crystal panel cutting device includes a material feeding portion, a cutting portion, a splintering portion, and a transporting apparatus. The transporting apparatus includes a gripping mechanism for gripping the liquid crystal panel and for pulling panel debris generated during the splintering process. Typical gripping arms includes a metallic fixing block and a plastic pad connecting to the metallic fixing block. A gripping space is formed between the two gripping arms. The dimension of the plastic pad is usually 40* 13 mm. The maximum gripping force is 10000 μm, and the two gripping arms are mainly controlled by a cylinder. However, such gripping mechanism usually is not able to stably grip the panel debris with a thin thickness, such as under 0.5 T, for the reason that such panel has greater extensibility. As such, the panel debris may not be pulled and be detached.

### SUMMARY

In order to overcome the above problem, a gripping mechanism is provided for liquid crystal panel manufacturing process. The gripping mechanism is capable of stably gripping the liquid crystal panel and pulling the panel debris after the panel is splintered. The gripping mechanism has great gripping effects for the liquid crystal panel with thinner thickness.

In one aspect, a gripping mechanism includes: a first gripping arm and a second gripping arm movable with respect to each other, each of the gripping arms includes a fixing arm and a clasping portion connecting to the fixing arm, the clasping portion of the two gripping arms are arranged opposite to each other to form a gripping space therebetween; and wherein the clasping portion includes a vacuum hole connecting to a vacuum controlling device, and the vacuum controlling device sucks a gripped target via performing a vacuum suction by the vacuum hole when the gripping mechanism performs a gripping process.

Wherein the gripping mechanism includes a fixing axis, first ends of the first gripping arms and the second gripping arm connects to the fixing axis in a rotatable manner, second ends of the first gripping arm and the second gripping arm moves closer or father with respect to each other so as to grip or loose the target.

Wherein the first gripping arm and the second gripping arm are controlled by a servo power engine such that the first gripping arm and the second gripping arm are rotatable with respect to the fixing axis.

Wherein all of the vacuum holes relating to one clasping portion connects to a cylinder of the vacuum controlling device via a vacuum tube, and the vacuum tube joins up with the vacuum hole of the clasping portion via an upper side of the fixing arm.

Wherein all of the vacuum holes relating to one clasping portion connects to a cylinder of the vacuum controlling device via a vacuum tube, and the vacuum tube joins up with the vacuum hole of the clasping portion via an upper side of the fixing arm.

Wherein the fixing arm and the clasping portion are tablet-shaped structure.

Wherein the edge surfaces of the fixing arm and the clasping portion align with each other at the second ends of the first gripping arm and the second gripping arm.

Wherein the clasping portion is rectangular-shaped, the length of the clasping portion is in a range between 80 and 100 mm, and the width of the clasping portion is in a range between 30 and 50 mm.

Wherein the length of the clasping portion is 80 mm, and the width of the clasping portion is 30 mm.

In another aspect, a cutting device for cutting liquid crystal panel includes: a main body and a transporting apparatus for liquid crystal panels, the transporting apparatus includes a plurality of gripping mechanisms for gripping the liquid crystal panels, wherein the gripping mechanism includes: a first gripping arm and a second gripping arm movable with respect to each other, each of the gripping arms includes a fixing arm and a clasping portion connecting to the fixing arm, the clasping portion of the two gripping arms are arranged opposite to each other to form a gripping space therebetween; and wherein the clasping portion includes a vacuum hole connecting to a vacuum controlling device, and the vacuum controlling device sucks a gripped target via performing a vacuum suction by the vacuum hole when the gripping mechanism performs a gripping process.

In another aspect, a cutting method of liquid crystal panels, the cutting method adopts a cutting device to cut the liquid crystal panels and to detach debris of the liquid crystal panel after being cut, the method includes: (a) controlling a first gripping arm and a second gripping arm to move toward each other such that a clasping portion grips the liquid crystal panel via mechanical forces; (b) controlling a vacuum controlling device to suck the liquid crystal panel via a vacuum suction by a vacuum hole; (c) a portion of the liquid crystal panel gripped by a gripping mechanism forms the debris of the liquid crystal panel after the liquid crystal panel is cut and fragmented, and the gripping mechanism pulls the debris to detach from the liquid crystal panel; and (d) the gripping mechanism transports the debris of the liquid crystal panel to a debris area.

Comparing with current technology, the gripping mechanism includes a vacuum hole. When gripping the liquid crystal panel, a vacuum controlling device sucks the liquid crystal panel by performing the vacuum suction via the vacuum hole so as to increase the gripping forces of the gripping arm, especially for the panel debris with thinner thickness. Preferably, the first gripping arm and the second gripping arm are controlled by a servo power engine so as to move respect to each other. In addition, the synchronization of the gripping mechanisms is better when the gripping mechanisms are installed on the cutting device. Preferably, the length and the width of the clasping portion are increased so as to increase the gripping force of the gripping mechanism. As such, a better gripping effect is obtained for the liquid crystal panel debris with larger width. That is, the debris with larger width may be smoothly detached from the liquid crystal panel. In this way, the operation efficiency is enhanced and the operation cost is reduced.

### BRIEF DESCRIPTION OF THE DRAWINGS

FIG. 1 is a front view of the gripping mechanism in a loosening state in accordance with one embodiment.

FIG. 2 is a right view of the gripping mechanism in a loosening state in accordance with one embodiment.

FIG. 3 is a right view of the gripping mechanism in a gripping state in accordance with one embodiment.

FIG. 4 is a schematic view of the vacuum hole of the gripping mechanism, which connects to the vacuum controlling device via a vacuum tube, in accordance with one embodiment.

FIGS. 5a-5d are schematic views showing the process of the gripping mechanism grips the liquid crystal panel and then the panel debris are pulled so as to be detached from the liquid crystal panel.

### DETAILED DESCRIPTION OF THE EMBODIMENTS

Embodiments of the invention will now be described more fully hereinafter with reference to the accompanying drawings, in which embodiments of the invention are shown.

As stated above, the gripping mechanism of the claimed invention overcomes the above-mentioned problem. The gripping mechanism includes a first gripping arm and a second gripping arm movable with respect to each other. Each of the gripping arms includes a fixing arm and clasping portion connecting to the fixing arms. The gripping portions of the two gripping arms are arranged opposite to each other for from a gripping space between the two clasping portions. The clasping portion includes the vacuum hole connecting to one vacuum controlling device. When the gripping mechanism performs the gripping process, the vacuum controlling device sucks the gripped target via the vacuum suction by the vacuum hole. By arranging the vacuum hole on the clasping portion, the gripping force of the gripping arm is enhanced, especially for the liquid crystal panel debris with thinner thickness.

Typical gripping arms are controlled by the cylinder. When the plurality of gripping arms are installed on the cutting device, synchronization of the gripping mechanisms is bad, and this may damage the liquid crystal panel when being gripped. To overcome the problem, the first gripping arm and the second gripping arm are controlled by the servo power engine so as to move respect to each other. In addition, the synchronization of the gripping mechanisms is good when the gripping mechanisms are installed on the cutting device.

For typical gripping mechanisms, the gripping space is formed between the plastic pads of the two gripping arms. Generally, the dimension of the plastic pads is 40*13 mm, and the maximum gripping force is 10000 μm. At this moment, for the panel debris with larger width, such as over 40 mm, as the gripping force is not enough, and thus the debris cannot be smoothly pulled by the gripping mechanism. To overcome the problem, preferably, the clasping portion is rectangular-shaped. Also, the length and the width of the clasping portion are increased to increase the gripping force of the gripping mechanism. The length may be within the range between 80 and 100 mm, and the width may be within the range between 30 and 50 mm. In this way, the gripping effect is better for the panel debris with larger width.

The embodiments will be described with reference to the accompany figures hereinafter.

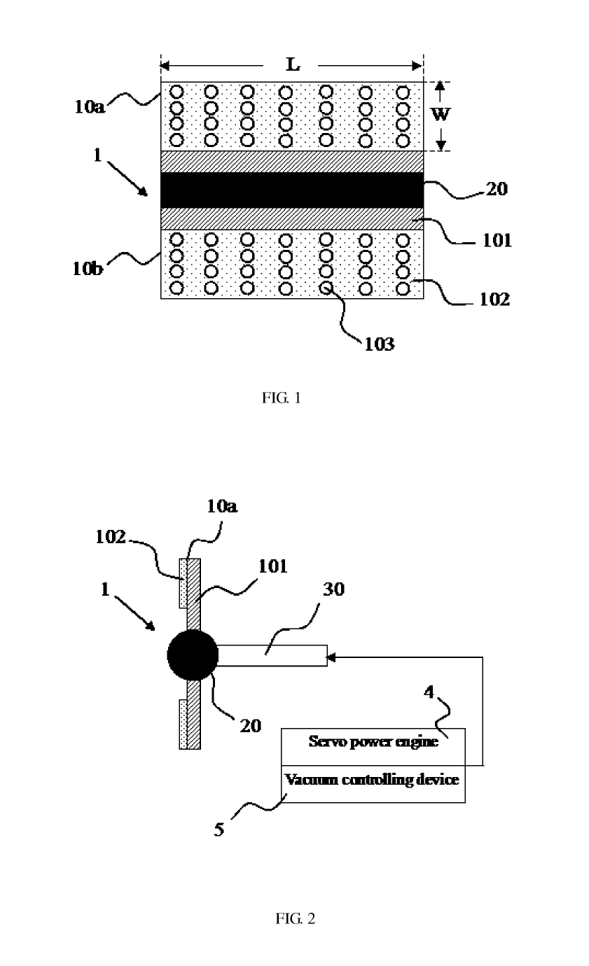

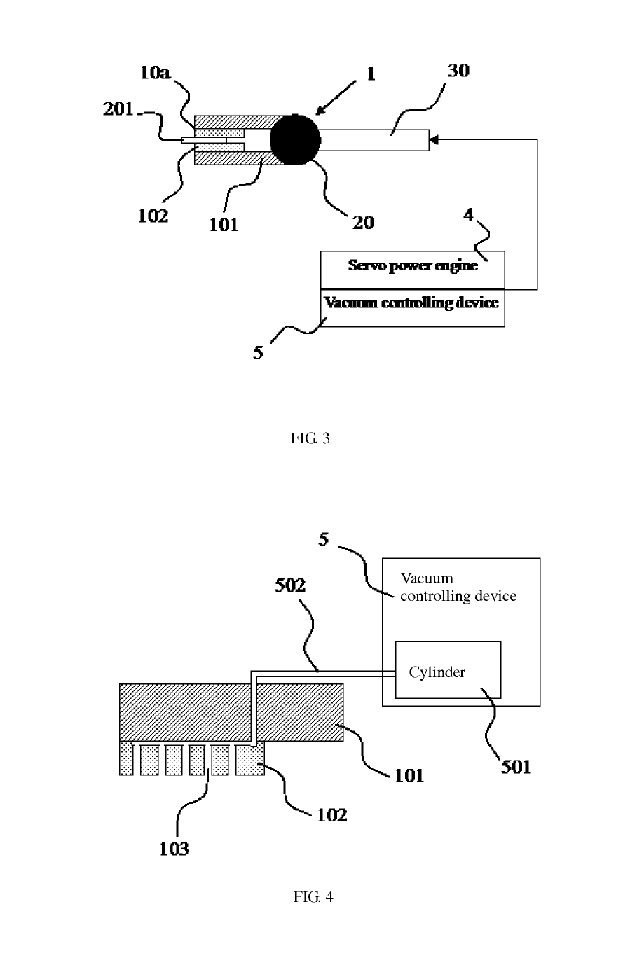

The gripping mechanism is mainly adopted in the cutting device for liquid crystal panel(“cutting device”). Generally, the cutting device includes a main body and a transporting apparatus for liquid crystal panel. The transporting apparatus includes a plurality of gripping mechanisms for gripping the liquid crystal panel. Referring to FIGS. 1 to 3, the gripping mechanism 1 includes a first gripping arm 10a and a second gripping arm 10b movable with respect to each other. Each of the first gripping arm 10a and the second gripping arm 10b includes a fixing arm 101 and a clasping portion 102 connecting to the fixing arm 101. The clasping portion 102 of the first gripping arm 10a and the second gripping arm 10b are arranged opposite to each other to form a gripping space therebetween. The fixing arm 101 is made by metallic material, such as aluminum alloy. The clasping portion 102 is made by plastic material, such as Polyetheretherketone resin (PEEK). The clasping portion 102 connects to the fixing arm 101 via screw fastening members. The clasping portion 102 includes vacuum holes 103 connecting to one vacuum controlling device 5. Specifically, as shown in FIG. 4, the vacuum hole 103 is arranged within the clasping portion 102. All of the vacuum holes 103 relating to one clasping portion 102 connects to a cylinder 501 of a vacuum controlling device 5 via a vacuum tube 502. The vacuum tube 502 joins up with the vacuum hole 103 of the clasping portion 102 via an upper side of the fixing arm 101. In this way, the electromagnetic value of the vacuum controlling device 5 controls whether a vacuum suction has to be conducted. When the gripping mechanism 1 performs a gripping process, the vacuum controlling device 5 sucks the gripped target via performing the vacuum suction by the vacuum hole 103. As shown in FIG. 3, the gripped target is the panel debris 201.

Further, in the embodiment, the gripping mechanism 1 includes a fixing axis 20. First ends of the first gripping arm 10a and the second gripping arm 10b connects to the fixing axis 20 in a rotatable manner. Second ends of the first gripping arm 10a and the second gripping arm 10b moves closer or farther with respect to each other such that the gripping mechanism 1 grips or looses the target. The gripping mechanism 1 further includes a connecting arm 30 for connecting the gripping mechanism 1 to the main body of the cutting device. One end of the connecting arm 30 connects to the fixing axis 20, and the other end of the connecting arm 30 connects to the main body of the cutting device. In the embodiment, the first gripping arm 10a and the second gripping arm 10b are controlled by a servo power engine 4 such that the first gripping arm 10a and the second gripping arm 10b are rotatable with respect to the fixing axis 20. As the gripping mechanisms are needed to grip the liquid crystal panel simultaneously, the liquid crystal panel may be damaged due to inconsistent gripping forces. Generally, the gripping mechanism is controlled by the cylinder, and each of the gripping mechanisms is controlled by one cylinder. As the gripping mechanism is controlled by air inflow of the cylinder, and thus it is difficult to control the gripping mechanisms to grip simultaneously, especially for the condition that the air channel has crinkles and damages. In the embodiment, the servo power engine is adopted to control the gripping process of the gripping mechanisms. The precision is calculated and controlled by encoders, and thus the gripping mechanisms are capable of precisely gripping at the same time. In this way, the above-mentioned problem is overcome.

In the embodiment, the fixing arm 101 and the clasping portion 102 are tablet-shaped structure. In addition, the edge surfaces of the fixing arm 101 and the clasping portion 102 align with each other at second ends of the first gripping arm and the second gripping arm. As stated above, in order to increase the gripping force, the length and the width of the clasping portion 102 may be increased. As shown in FIG. 1, in the embodiment, the clasping portion 102 is rectangular-shaped, and the length (L) equals to 80 mm, and the width (W) equals to 30 mm.

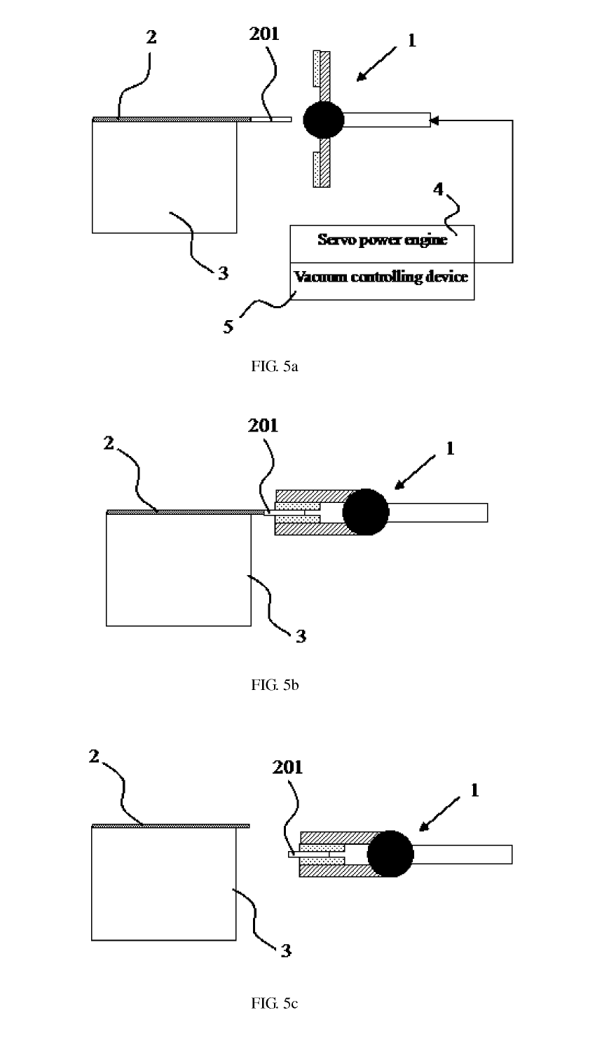

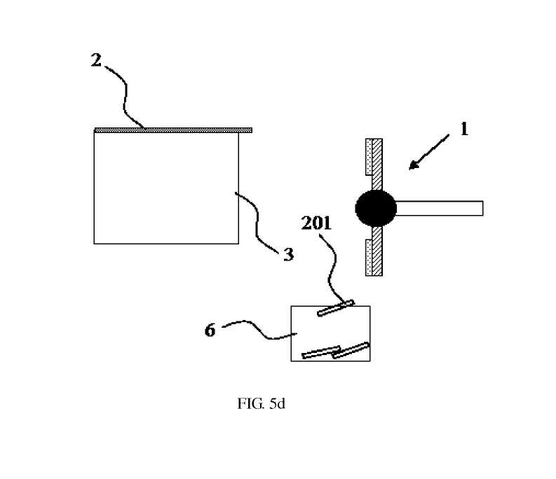

The cutting method of the liquid crystal panel will be described hereinafter with reference to FIG. 5. The above-mentioned cutting device is adopted. The gripping mechanism 1 is adopted to grip the liquid crystal panel and to detach the debris after the liquid crystal panel is cut. The cutting method includes the following steps. In step (1), the liquid crystal panel 2 is arranged on a supporting platform 3 as shown in FIG. 5a.

In step (2), the servo power engine 4 controls the first gripping arm 10a and the second gripping arm 10b to rotate with respect to the fixing axis 20. In this way, the first gripping arm 10a and the second gripping arm 10b move toward each other such that the clasping portion 102 grips the liquid crystal panel 2 via mechanical forces as shown in FIG. 5b.

In step (3), the vacuum controlling device 5 is controlled to suck the liquid crystal panel 2 via the vacuum suction by the vacuum hole 103 of the clasping portion 102.

In step (4), after the liquid crystal panel is cut and fragmented, the portion of the liquid crystal panel gripped by the gripping mechanism 1 forms the panel debris 201. As shown in FIG. 5c, the gripping mechanism 1 pulls the panel debris 201 to detach from the liquid crystal panel 2.

In step (5), the gripping mechanism 1 transports the panel debris 201 to a debris area 6. The vacuum controlling device 5 and the servo power engine 4 loose the first gripping arm 10a and the second gripping arm 10b of the gripping mechanism 1 such that the panel debris 201 is detached and falls within the debris area 6 as shown in FIG. 5d.

In view of the above, the gripping mechanism includes the vacuum hole on the clasping portion. When gripping the liquid crystal panel, the vacuum control device performs the vacuum suction by the vacuum hole so as to sucks the liquid crystal panel. The strength and the uniformity of the gripping forces of the gripping mechanism are enhanced, especially for the liquid crystal panel debris with a thinner thickness. Preferably, the gripping mechanism is controlled by the servo power engine such that the first gripping arm and the second gripping arm are movable with respect to each other. In addition, the plurality of gripping mechanisms of the cutting device can operate simultaneously. Preferably, the length and the width of the clasping portion are increased so as to increase the gripping force of the gripping mechanism. As such, a better gripping effect is obtained for the liquid crystal panel debris with larger width, that is, the debris with larger width may be smoothly detached from the liquid crystal panel. In this way, the operation efficiency is enhanced and the operation cost is reduced.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . .” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A gripping mechanism, comprising:
a first gripping arm and a second gripping arm movable with respect to each other, each of the gripping arms comprises a fixing arm and a clasping portion connecting to the fixing arm, the clasping portion of the two gripping arms are arranged opposite to each other to form a gripping space therebetween; and
wherein the clasping portion comprises a vacuum hole connecting to a vacuum controlling device, and the vacuum controlling device sucks a gripped target via performing a vacuum suction by the vacuum hole when the gripping mechanism performs a gripping process.

2. The gripping mechanism as claimed in claim 1, wherein the gripping mechanism comprises a fixing axis, first ends of the first gripping arms and the second gripping arm connects to the fixing axis in a rotatable manner, second ends of the first gripping arm and the second gripping arm moves closer or father with respect to each other so as to grip or loose the target.

3. The gripping mechanism as claimed in claim 2, wherein the first gripping arm and the second gripping arm are controlled by a servo power engine such that the first gripping arm and the second gripping arm are rotatable with respect to the fixing axis.

4. The gripping mechanism as claimed in claim 2, wherein all of the vacuum holes relating to one clasping portion connects to a cylinder of the vacuum controlling device via a vacuum tube, and the vacuum tube joins up with the vacuum hole of the clasping portion via an upper side of the fixing arm.

5. The gripping mechanism as claimed in claim 3, wherein all of the vacuum holes relating to one clasping portion connects to a cylinder of the vacuum controlling device via a vacuum tube, and the vacuum tube joins up with the vacuum hole of the clasping portion via an upper side of the fixing arm.

6. The gripping mechanism as claimed in claim 5, wherein the fixing arm and the clasping portion are tablet-shaped structure.

7. The gripping mechanism as claimed in claim 6, wherein the edge surfaces of the fixing arm and the clasping portion align with each other at the second ends of the first gripping arm and the second gripping arm.

8. The gripping mechanism as claimed in claim 6, wherein the clasping portion is rectangular-shaped, the length of the clasping portion is in a range between 80 and 100 mm, and the width of the clasping portion is in a range between 30 and 50 mm.

9. The gripping mechanism as claimed in claim 8, wherein the length of the clasping portion is 80 mm, and the width of the clasping portion is 30 mm.

10. A cutting device of liquid crystal panels, comprising:
a main body and a transporting apparatus for liquid crystal panels, the transporting apparatus comprises a plurality of gripping mechanisms for gripping the liquid crystal panels, wherein the gripping mechanism comprises:
a first gripping arm and a second gripping arm movable with respect to each other, each of the gripping arms comprises a fixing arm and a clasping portion connecting to the fixing arm, the clasping portion of the two gripping arms are arranged opposite to each other to form a gripping space therebetween; and
wherein the clasping portion comprises a vacuum hole connecting to a vacuum controlling device, and the vacuum controlling device sucks a gripped target via performing a vacuum suction by the vacuum hole when the gripping mechanism performs a gripping process.

11. The cutting device of liquid crystal panels as claimed in claim 10, wherein the gripping mechanism comprises a fixing axis, first ends of the first gripping arms and the second gripping arm connects to the fixing axis in a rotatable manner, second ends of the first gripping arm and the second gripping arm moves closer or father with respect to each other so as to grip or loose the target.

12. The cutting device of liquid crystal panels as claimed in claim 11, wherein the first gripping arm and the second gripping arm are controlled by a servo power engine such that the first gripping arm and the second gripping arm are rotatable with respect to the fixing axis.

13. The cutting device of liquid crystal panels as claimed in claim 12, wherein all of the vacuum holes relating to one clasping portion connects to a cylinder of the vacuum controlling device via a vacuum tube, and the vacuum tube joins up with the vacuum hole of the clasping portion via an upper side of the fixing arm.

14. The cutting device of liquid crystal panels as claimed in claim 13, wherein the fixing arm and the clasping portion are tablet-shaped structure.

15. The cutting device of liquid crystal panels as claimed in claim 14, wherein the edge surfaces of the fixing arm and the clasping portion align with each other at the second ends of the first gripping arm and the second gripping arm.

16. The cutting device of liquid crystal panels as claimed in claim 14, wherein the clasping portion is rectangular-shaped, the length of the clasping portion is in a range between 80 and 100 mm, and the width of the clasping portion is in a range between 30 and 50 mm.

17. The cutting device of liquid crystal panels as claimed in claim 16, wherein the length of the clasping portion is 80 mm, and the width of the clasping portion is 30 mm.

18. A cutting method of liquid crystal panels, the cutting method adopts a cutting device to cut the liquid crystal panels and to detach debris of the liquid crystal panel after being cut, the method comprises:
(a) controlling a first gripping arm and a second gripping arm to move toward each other such that a clasping portion grips the liquid crystal panel via mechanical forces;
(b) controlling a vacuum controlling device to suck the liquid crystal panel via a vacuum suction by a vacuum hole;
(c) a portion of the liquid crystal panel gripped by a gripping mechanism forms the debris of the liquid crystal panel after the liquid crystal panel is cut and fragmented, and the gripping mechanism pulls the debris to detach from the liquid crystal panel;
(d) the gripping mechanism transports the debris of the liquid crystal panel to a debris area; and wherein
the cutting device comprises a main body and a transporting apparatus for liquid crystal panels, the transporting apparatus comprises a plurality of gripping mechanisms for gripping the liquid crystal panels, wherein the gripping mechanism comprises:
a first gripping arm and a second gripping arm movable with respect to each other, each of the gripping arms comprises a fixing arm and a clasping portion connecting to the fixing arm, the clasping portion of the two gripping arms are arranged opposite to each other to form a gripping space therebetween; and
wherein the clasping portion comprises a vacuum hole connecting to a vacuum controlling device, and the vacuum controlling device sucks a gripped target via performing a vacuum suction by the vacuum hole when the gripping mechanism performs a gripping process.

19. The cutting method of liquid crystal panels as claimed in claim 18, wherein the gripping mechanism comprises a fixing axis, first ends of the first gripping arms and the second gripping arm connects to the fixing axis in a rotatable manner, second ends of the first gripping arm and the second gripping arm moves closer or father with respect to each other so as to grip or loose the target.

20. The cutting method of liquid crystal panels as claimed in claim 19, wherein the first gripping arm and the second gripping arm are controlled by a servo power engine such that the first gripping arm and the second gripping arm are rotatable with respect to the fixing axis.
